(19) United States
(12) Patent Application Publication
(10) Pub. No.: US 2022/0290496 A1
(43) Pub. Date: Sep. 15, 2022

(54) SHADING DEVICE

(71) Applicant: STOBAG AG, Muri (CH)

(72) Inventor: Fabian HASLER, Muri (CH)

(73) Assignee: Stobag AG, Muri (CH)

(21) Appl. No.: 17/831,527

(22) Filed: Jun. 3, 2022

Related U.S. Application Data
(63) Continuation of application No. PCT/EP2020/082811, filed on Nov. 20, 2021.

(30) Foreign Application Priority Data
Dec. 4, 2019 (DE) 10 2019 008 410.1

(51) Int. Cl. E06B 9/58; E06B 9/42

(52) U.S. Cl. CPC E06B 9/581; E06B 9/42

(57) ABSTRACT

A shading device having a cloth that can be spread out, and is connected to a lead bar at its end pointing in the spreading-out direction and engages with a profiled guide rail on at least one side edge. The profiled guide rail is arranged in a channel-like chamber of a profiled holding rail and is resiliently supported on the profiled holding rail by means of a spring device, the spring device having a profiled spring rail. The profiled guide rail is inserted into a receiving space of the profiled spring rail that is delimited by spring clips and said profiled guide rail is floatingly mounted in the profiled spring rail, and the profiled spring rail is floatingly mounted in the channel-like chamber of the profiled holding rail and is supported on an internal wall of the chamber by means of at least one arm.

This nonprovisional application is a continuation of International Application No. PCT/EP2020/082811, which was filed on Nov. 20, 2020, and which claims priority to German Patent Application No. 10 2019 008 410.1, which was filed in Germany on Dec. 4, 2019, and which are both herein incorporated by reference.

### BACKGROUND OF THE INVENTION

### Field of the Invention

The present invention relates to a shading device comprising a cloth that can be spread out, is connected to a lead bar at its end pointing in the spreading-out direction and engages with a profiled guide rail on at least one side edge, the profiled guide rail being arranged in a channel-like chamber of a profiled holding rail and being resiliently supported on the profiled holding rail by means of a spring device.

### Description of the Background Art

A corresponding shading device can be, for example, a vertical awning in which the cloth is wound up on an upper shaft and can be pulled off said shaft vertically downward. However, the invention is not limited to vertical awnings and can also be used with other orientations of the cloth. By way of example, however, the following is based on a vertically oriented shading device, as shown in DE 10 2011 118 859 A1, which is incorporated herein by reference.

The cloth is wound up on the upper shaft and is connected, at its lower end that faces away from the upper shaft in the spread-out state, to a lead bar which gives the cloth sufficient stability while said cloth is being spread out and while said cloth is being pulled off the shaft. In order to also give the cloth improved stability at the side edges, which extend from the shaft to the lead bar, and to prevent light from passing through at the side edges, it is known for the side edges of the cloth to also be held. A lateral bracket used for this purpose comprises a bar-like profiled guide rail, into which the side edge of the cloth is inserted and in which said side edge is preferably interlockingly held. When the cloth is being spread out or pulled off, the side edge of the cloth is moved along the profiled guide rail and held therein.

The profiled guide rail, which is preferably made of plastics material and is formed by an extruded profile, is arranged inside a bar-like profiled holding rail, which can be secured to a building. The profiled holding rail is preferably also formed by a single extruded profile or multiple extruded profiles put together and can be made of plastics material, aluminum or metal.

The profiled guide rail is floatingly mounted in the profiled holding rail, i.e., it can perform movements relative to the profiled holding rail, in particular perpendicularly to its own longitudinal extent. This makes it possible for external loads which act on the cloth, for example wind loads, to be absorbed and dissipated without excessive stresses arising in the cloth which could lead to it getting damaged. The profiled guide rail can be floatingly mounted in the profiled holding rail by a spring device which acts between the profiled guide rail and the profiled holding rail.

According to DE 10 2011 118 859 A1, the spring device is formed by a large number of spring clips made of plastics material, which are placed and snapped onto the side of the profiled guide rail. However, this is disadvantageous in that it is very time-consuming to produce and install the spring clips and the profiled guide rail is only mounted by the spring clips, i.e., only at a few points, with stress peaks possibly occurring at the spring clips.

A shading device which has an outer profiled holding rail comprising a chamber into which a profiled guide rail is inserted is known from EP 3 040 505 A1. The profiled guide rail is connected to a cloth in the conventional manner, is floatingly mounted in the profiled holding rail and rests against a stop on its side facing away from the cloth. Two stop rails are attached to the profiled holding rail next to one another at a distance, which stop rails are used as a stop for the profiled guide rail in the spreading-out direction. In this way, the profiled guide rail cannot be pulled out of the chamber of the profiled holding rail. By means of a spring, the profiled guide rail is preloaded against the stop arranged on the rear side facing away from the cloth. This design requires a large number of components and is therefore difficult to assemble. In addition, the spring effect is achieved solely by the separate spring, which acts on the profiled guide rail in a punctiform manner.

### SUMMARY OF THE INVENTION

It is therefore an object of the present invention to provide a shading device in which the profiled guide rail is resiliently supported on the profiled holding rail across a large area in a structurally simple manner.

This problem is solved according to an exemplary embodiment of the invention by a shading device having a spring device that has a profiled spring rail, the profiled guide rail is inserted into a receiving space of the profiled spring rail that is delimited by spring clips and said profiled guide rail is floatingly mounted in the profiled spring rail, and the profiled spring rail is floatingly mounted in the channel-like chamber of the profiled holding rail and is supported on an internal wall of the chamber by means of at least one support arm.

The profiled spring rail can be a single extruded profile, i.e., the profiled spring rail can have a constant cross section over its entire length. The profiled spring rail can be made of plastics material and is arranged between the profiled guide rail and the profiled holding rail with consideration of the flow of forces, i.e., forces acting on the cloth are transferred from the cloth to the profiled guide rail. The profiled guide rail can be resiliently held inside the profiled spring rail and transfers the forces to said profiled spring rail at least in part, thus deforming said profiled spring rail. The forces are transferred from the profiled spring rail to the profiled holding rail and dissipated therefrom.

The formation of the channel-like chamber in the profiled holding rail makes it possible to either push the profiled spring rail into the profiled holding rail from the end of the channel-like chamber or to insert said profiled spring rail into the chamber from the side of the profiled holding rail facing the cloth. In any case, the profiled spring rail can be installed very simply and quickly. The chamber ensures that the profiled spring rail is correctly positioned. Since the profiled spring rail is inherently resilient and deformable, it can adapt to the geometric conditions inside the chamber.

The profiled spring rail can be supported on the internal wall of the chamber by means of at least one support arm. The support arm can be an integral component of the profiled spring rail and can be formed on a base portion of the profiled spring rail such that it projects freely therefrom. The profiled spring rail can have at least two support arms. These support arms can be designed such that said support arms together with the base portion of the profiled spring rail that connects them form a C-shaped cross-sectional region of the profiled spring rail.

The support arms can rest against the wall of the chamber and/or engage behind projections or contact surfaces of the profiled holding rail so that the profiled spring rail is securely positioned in the chamber in an interlocking manner.

In order to hold the profiled guide rail in the profiled spring rail, the profiled spring rail can have a channel-like receiving space into which the profiled guide rail is inserted in such a way that the profiled guide rail can slide inside the receiving space relative to the profiled spring rail transversely to its own longitudinal extension. The receiving space can be delimited by spring clips of the profiled spring rail, which are preferably an integral component of the profiled spring rail and preferably rest against the profiled guide rail under spring force, i.e., are clamped against the profiled guide rail from the outside, for example. The spring clips can be arranged between the support arms of the profiled spring rail in the interior of the profiled spring rail and form together with the base portion of the profiled spring rail a further C-shaped cross-sectional region. In particular, the base portion of the profiled spring rail together with the support arms and the spring clips can form a C-in-C-shaped cross section, with the two C-shaped cross-sectional regions being connected or converging at their common base portion.

The receiving space of the profiled spring rail can have an access opening and, when the cloth is in the unloaded state, the profiled guide rail can either be completely received in the receiving space or can protrude slightly therefrom at the access opening. The profiled guide rail can be moved relative to the profiled spring rail, with the spring clips being elastically deformed when the profiled guide rail is moved. In particular, the profiled guide rail can be partially pulled out of the receiving space of the profiled spring rail through the access opening, with elastic deformation of the spring clips, as far as a maximum pull-out position. In the pull-out position, the profiled guide rail protrudes from the receiving space, but is not pulled out of it completely, and therefore the spring clips still exert a holding force on the profiled guide rail.

In its maximum pull-out position, the profiled guide rail can rest against a stop, which reliably prevents the profiled guide rail from being pulled out further from the receiving space of the profiled spring rail. The stop can be formed on the profiled holding rail, which usually has a higher stability, particularly if it is made of aluminum or metal.

The profiled guide rail can have a trapezoidal cross-sectional shape or a cross-sectional shape with some other form of tapering, the cross section decreasing toward the cloth and toward the access opening of the receiving space. When the profiled guide rail is pulled out of the receiving space, the spring clips are opened out by the profiled guide rail, which has a conical cross section, and, in response, exert an external clamping force on the profiled guide rail.

The shape and orientation of the spring clips of the profiled spring rail are preferably selected such that the spring clips are constantly in contact with the outside of the profiled guide rail. The maximum pull-out movement of the profiled guide rail from the receiving space of the profiled spring rail is limited by the stop with which the profiled guide rail comes into contact in the pull-out position.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a detail of the shading device in a perspective view,

FIG. 2 is the cross section II-II from FIG. 1, and

FIG. 3 is a cross-sectional view corresponding to FIG. 2, with the profiled guide rail being in its maximum pull-out position.

### DETAILED DESCRIPTION

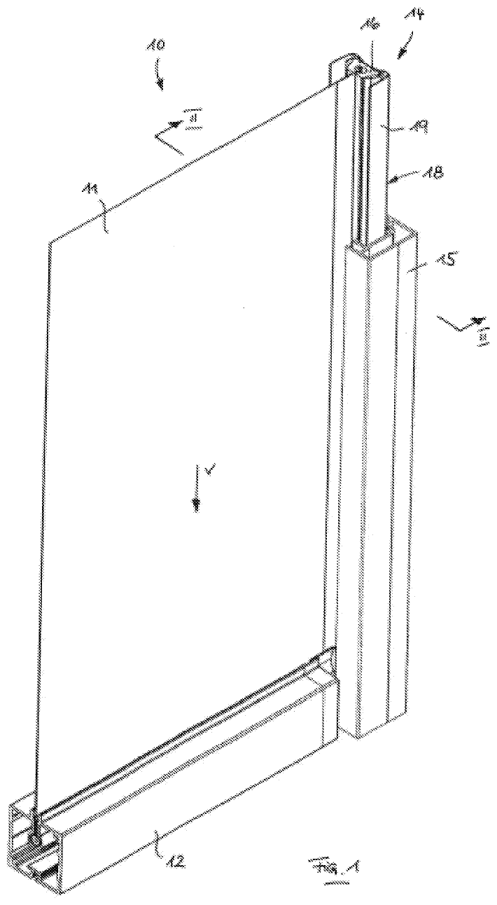

FIG. 1 shows a detail of a shading device 10 which has a cloth 11 which is connected, at its lower end, to a transverse lead bar 12 in a known manner. At the upper end of the cloth 11, there is a cloth shaft (not shown) on which the cloth 11 can be wound up and from which it can be unwound by pulling the lead bar 12 downward in the spreading-out direction V.

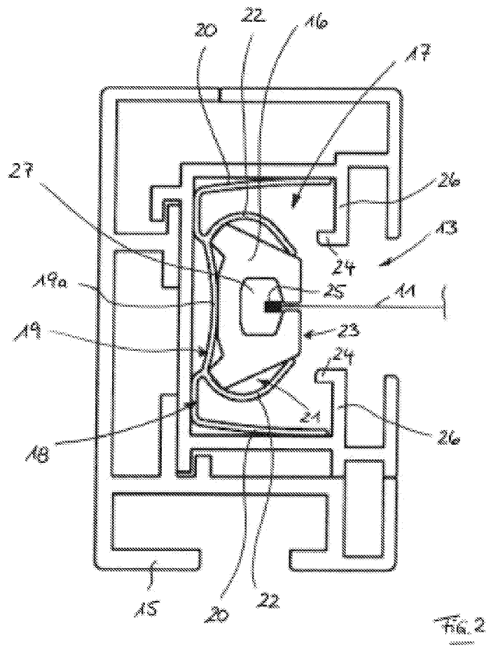

A lateral bracket 14 is provided along the vertical side edge of the cloth 11, which bracket has a vertical bar-like profiled holding rail 15, which is preferably made of aluminum or metal and can be attached to a building wall, for example. As shown in particular in FIG. 2, the profiled holding rail 15 has a channel-like chamber 17 in its interior, which chamber has a through-opening 13 on its side facing the cloth 11.

The cloth 11 has, on its vertical side edge, a bead-like thickened portion 25 which preferably extends over the entire height and by which the cloth 11 is inserted into a recess 27 in a profiled guide rail 16. In this way, the cloth 11 is interlockingly connected to the profiled guide rail 16 and can slide relative thereto in the longitudinal direction of the profiled guide rail. The profiled guide rail 16 is preferably made of plastics material and is also designed as an extruded profile. It has a cross section which tapers from its end facing away from the cloth 11 toward the cloth 11 and is conical or trapezoidal. The dimensions of the chamber 17 and the profiled guide rail 16 are adapted to one another such that the profiled guide rail 16 can move inside the chamber 17 transversely to its longitudinal direction but cannot be completely removed from the chamber 17 through the through-opening 13.

The profiled guide rail 16 is floatingly mounted in the chamber 17 of the profiled holding rail 15 by means of a spring device 18. The spring device 18 is formed by a profiled spring rail 19 which is inserted into the chamber 17. The profiled spring rail 19 is made of plastics material and is also designed as an extruded profile. On its side facing away from the cloth 11, the profiled spring rail 19 has a base portion 19a, on each of the opposite ends of which a support arm 20 is integrally formed. The base portion 19a and the two support arms 20 form a C-shaped outer cross-sectional region of the profiled spring rail 19.

Between the two support arms 20, two spring clips 22 are formed on the base portion 19a of the profiled spring rail 19. A receiving space 21 is formed between the spring clips 22, into which space the profiled guide rail 16 is inserted. The spring clips 22 surround the profiled guide rails 16 in portions and exert a clamping force on the profiled guide rail 16 that holds the profiled guide rail 16 in the receiving space 21. The spring clips 22 form together with the base portion 19a a further C-shaped cross-sectional region, and therefore the profiled spring rail 19 has a C-in-C cross section.

Projections 26 projecting into the through-opening 13 are formed on the profiled holding rail 15, which projections reduce the width of the through-opening 13 such that the profiled guide rail 16 cannot be pulled out through the through-opening 13. Stops 24 are formed on the projections 26, which stops limit a maximum pull-out movement of the profiled guide rail 16 from the inner chamber 17 of the profiled holding rail 15 and from the receiving space 21 of the profiled spring rail 19.

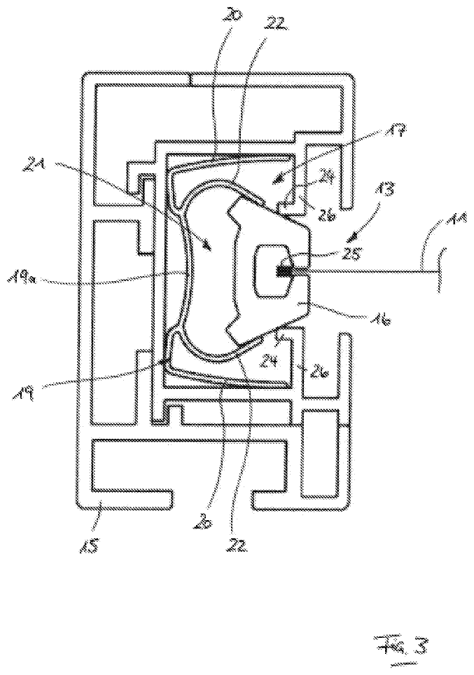

If an external force, for example a wind force, acts on the cloth 11, this results in the cloth 11 exerting a tensile force on the profiled guide rail 16 via the thickened portion 25, as a result of which the profiled guide rail 16 is pulled out of the receiving space 21 of the profiled spring rail 19 with elastic deformation of the spring clips 22 and counter to the spring forces exerted on the profiled guide rail 16 by the spring clips 22. The maximum pull-out position is defined by the profiled guide rail 16 resting against the stops 24 of the projections 26 of the profiled holding rail 15, as shown in FIG. 3. The profiled guide rail 16 is, however, still located, with its rear portion facing away from the cloth 11, inside the receiving space 21 of the profiled spring rail 19 and is held by the deformed spring clips 22. As soon as the load on the cloth 11 is released, the spring clips 22 pull the profiled guide rail 16 back into the receiving space 21 of the profiled spring rail 19 such that the starting position shown in FIG. 2 is reached again.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A shading device comprising:
a profiled guide rail;
a lead bar; and
a cloth adapted to be spread out and is connected to the lead bar at an end pointing in a spreading-out direction, the cloth engaging with the profiled guide rail on at least one side edge, the profiled guide rail being arranged in a channel-like chamber of a profiled holding rail and being resiliently supported on the profiled holding rail via a spring device,
wherein the spring device has a profiled spring rail,
wherein the profiled guide rail is inserted into a receiving space of the profiled spring rail that is delimited by spring clips, and
wherein the profiled guide rail is floatingly mounted in the profiled spring rail, and
wherein the profiled spring rail is floatingly mounted in the channel-like chamber of the profiled holding rail and is supported on an internal wall of the chamber via at least one support arm, and
wherein the spring clips together with the base portion form a C-shaped cross-sectional region of the profiled spring rail.

2. The shading device according to claim 1, wherein the support arm is an integral component of the profiled spring rail.

3. The shading device according to claim 1, wherein the profiled spring rail has at least two support arms.

4. The shading device according to claim 3, wherein the support arms together with a base portion that connects them form a C-shaped cross-sectional region of the profiled spring rail.

5. The shading device according to claim 4, wherein the base portion of the profiled spring rail together with the support arms and the spring clips form a C-in-C-shaped cross section.

6. The shading device according to claim 1, wherein the spring clips are clamped against the profiled guide rail from an outside.

7. The shading device according to claim 1, wherein the receiving space has an access opening, and wherein the profiled guide rail is adapted to be partially pulled out of the receiving space of the profiled spring rail through the access opening with elastic deformation of the spring clips as far as a maximum pull-out position.

8. The shading device according to claim 7, wherein the profiled guide rail rests against a stop in the maximum pull-out position.

9. The shading device according to claim 8, wherein the stop is formed on the profiled holding rail.

10. The shading device according to claim 7, wherein the profiled guide rail has a trapezoidal cross section that tapers toward the access opening.
